(19) United States
(12) Patent Application Publication
(10) Pub. No.: US 2023/0304889 A1
(43) Pub. Date: Sep. 28, 2023

(54) METHODS AND SYSTEMS FOR SYNCHRONIZING MEASURES OF STRUCTURAL DYNAMICS

(71) Applicant: Safehub Inc., San Francisco, CA (US)

(72) Inventor: Clement B. Barthes, Berkeley, CA (US)

(21) Appl. No.: 18/182,442

(22) Filed: Mar. 13, 2023

Related U.S. Application Data
(60) Provisional application No. 63/322,486, filed on Mar. 22, 2022.

(51) Int. Cl. G01M 5/00

(52) U.S. Cl. CPC G01M 5/0066

(57) ABSTRACT

A system for structural analytics includes spatially diverse motion detectors attached to a building to sense and analyze vibrations conducted through the building. Acceleration signals from the detectors are synchronized to facilitate measures of relative sensor acceleration in two horizontal and one vertical dimension. Phase offsets between vertical acceleration signals from separate detectors are measured to compute a phase offset between clock signals that serve as timing references in the diverse detectors. The phase offset is used to improve measures of relative acceleration in the horizontal dimensions, and thus measures of horizontally applied stress.

### BACKGROUND

How a building resonates with ground excitation is in large part a function of the soil properties (stratigraphy and material properties) supporting and surrounding the building. Soil properties significantly affect site amplification: soft soils will generally increase accelerations locally due to the conservation of energy. Soil properties also significantly impact the dynamic behavior of the combined soil-structure system.

Although there is detailed soil information available for major metropolitan areas of the West Coast of the United States, this information is based on the interpretation of large-scale geologic maps that are unable to accurately assess the local variability in soils conditions from site to site. Such maps do not have the ability to assess the variation in soil properties as a function of depth, further limiting their usefulness. Since earthquake property damage and loss is greatly influenced by soil amplification from earthquakes, accurate soils information will improve earthquake risk estimates. Better estimates can be obtained from in-situ geotechnical engineering evaluations, data for which is being made available by a new generation of networked motion detectors, devices that can sense and analyze the resonant properties of buildings. Some such motion detectors appear in U.S. Pat. No. 11,204,435, which issued on 21 Dec. 2021 and is incorporated herein by reference.

In taller buildings, synchronized acceleration signals from spatially diverse motion detectors signal how different parts of a building are displaced relative to one another and thus yield more accurate models of building flexion and concomitant stress. Moreover, the time difference between the arrival of a guided vibrational wave (symmetric and asymmetric) at spaced sensors can be used to characterize the event that produced the wave (e.g., windshear v. earthquake). Effective analysis of structural dynamics relies on accurate synchronization across spatially separate motion detectors.

### BRIEF DESCRIPTION OF THE DRAWINGS

The detailed description is illustrated by way of example, and not by way of limitation, in the figures of the accompanying drawings and in which like reference numerals refer to similar elements and in which:

FIG. 1A depicts analytical system in which spatially diverse top and bottom motion detectors 105T and 105B sense and analyze vibrations conducted through a structure 110.

FIG. 1B is a block diagram of motion detector 105 of FIG. 1A.

FIG. 2A depicts structure 110 and top and bottom motion detectors 105T and 105B as a system 200 in which bottom detector 105B is input—receives ground motion directly—and top detector 105T is output—receives the ground motion propagated through structure 110.

FIG. 2B depicts system 200 of FIG. 2A with delays Dly_d that represent a synchronization error between clock signals ClkB and ClkT within the bottom and top motion detectors 105B and 105T, respectively.

FIG. 3 includes plots 300 and 305 of magnitude and phase transfer functions that represent the response of a structure 110 as a function of frequency over a spectrum of from zero to 30 Hz.

FIG. 4 includes plots 400 and 405 that are like plots 300 and 305 of FIG. 3 but depict magnitude and phase transfer functions over a spectrum of from zero to 5 Hz.

FIG. 5 includes plots 500 and 505 of magnitude and phase transfer functions that represent the vertical response of a structure 110—the response of vertical LTI 210—over a spectrum of from zero to 30 Hz, the response of an ideal time delay system and the combination of the two.

FIG. 6 depicts a plot 600 of phase plot 505 of FIG. 5—the phase response of vertical LTI 210—over the narrower spectrum of from zero to 3 Hz, both with and without a time delay.

FIG. 7 is a flowchart 700 outlining a method of measuring acceleration, due to e.g. an earthquake, along a horizontal dimension between disparately timed motion sensors placed apart from one another within a structure.

### DETAILED DESCRIPTION

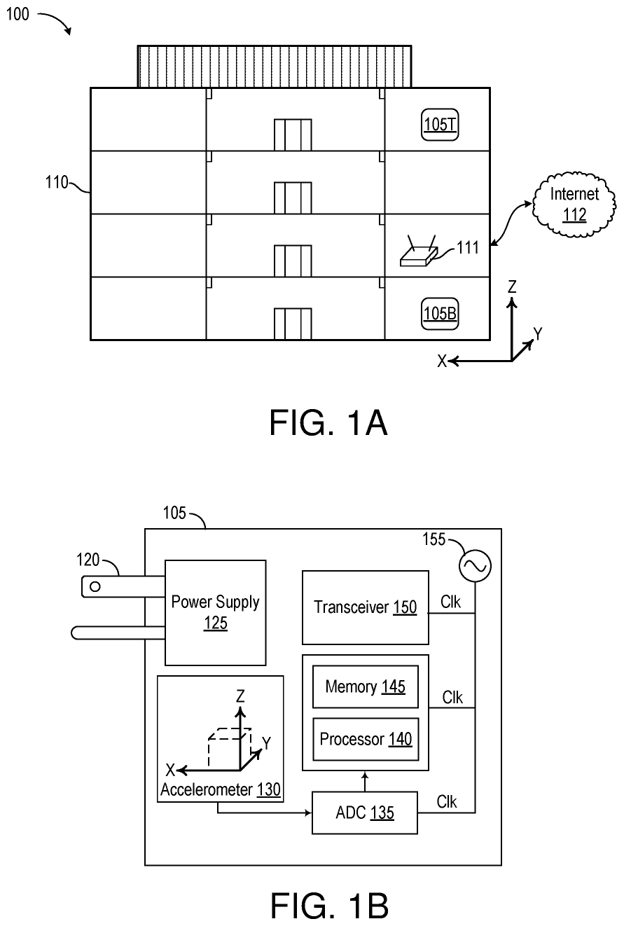

FIG. 1A depicts an analytical system 100 in which spatially diverse top and bottom motion detectors 105T and 105B sense and analyze vibrations conducted through a structure 110, e.g. a four-story building, to analyze structural dynamics. Acceleration signals from detectors 105T and 105B are synchronized between detectors to facilitate measures of relative sensor acceleration in three dimensions, horizontal X and Y dimensions and a vertical Z dimension. The primary destructive forces imposed on structure 110 by an earthquake or wind-shear event cause the top of structure 110 to move laterally (in the horizontal plane of the X and Y axes) relative to the base. Horizontal acceleration signals from top detector 105T will thus differ from those of bottom detector 105B, the difference being a function of the lateral displacement and stress applied between the top and bottom of structure 110. Detectors 105T and 105B calculate a phase offset between local timing references from vertical acceleration signals and use this phase offset to improve calculations of lateral stress.

A wireless router 111 connects motion detectors 105 to one another and the Internet 112 via e.g. Ethernet, Wi-Fi, or a cellular network depending on availability and data requirements. Networked motion detector can work separately, together, or with remote computational and storage resources to analyze and store measurements of building dynamics.

FIG. 1B is a block diagram of motion detector 105 of FIG. 1A. Electrodes 120 provide AC power to a power-supply 125 and conduct vibrations from structure 110 to a multi-axis (e.g. tri-axial) accelerometer 130 that produces analog acceleration signals in the X, Y, and Z dimension responsive to those vibrations. An analog-to-digital converter (ADC) 135 samples the acceleration signals in time to a clock signal Clk and conveys the resultant digital acceleration data to a processor 140 with access to local memory 145. The functions of processor 140 can be distributed across multiple processor dies and devices. A wired or wireless transceiver 150 can support communication protocols that allow device 105 to share data with other devices directly or via intermediate routers or cellular infrastructure.

An internal crystal clock source 155 provides clock signal Clk for local synchronization. Clock signals Clk between motion detectors 105T and 105B will be offset in phase, however. Clock signals Clk can be synchronized to the UTC (Coordinated Universal Time), a 24-hour time standard used as a basis for civil time, using the NTP (Network Time Protocol) for synchronizing TCP/IP networks. Unfortunately, relying on the NTP can lead to timing errors between motion detectors 105 on the order of 300 msec. This level of uncertainly reduces measurement accuracy for relative motion between detectors 105T and 105B, and thus places undesirable error margin around calculated values of lateral stress.

In FIG. 1A, structure 110 represents a typical four-story building with one motion detector 105B on the ground floor and another detector 105T at the top. When subjected to an earthquake, the lower detector 105 records the ground motion and the upper detector 105 the response of structure 110 at the elevated position. Approximating structure 110 as a linear, time-invariant (LTI) system for conducting vibrations, one can model the accelerometer signals from lower detector 105B as the vibrational input of ground motion and the accelerometer signals from upper detector 105T as the vibrational output. Detectors 105B and 105T can be placed elsewhere in other examples, and more and differently placed detectors can be used.

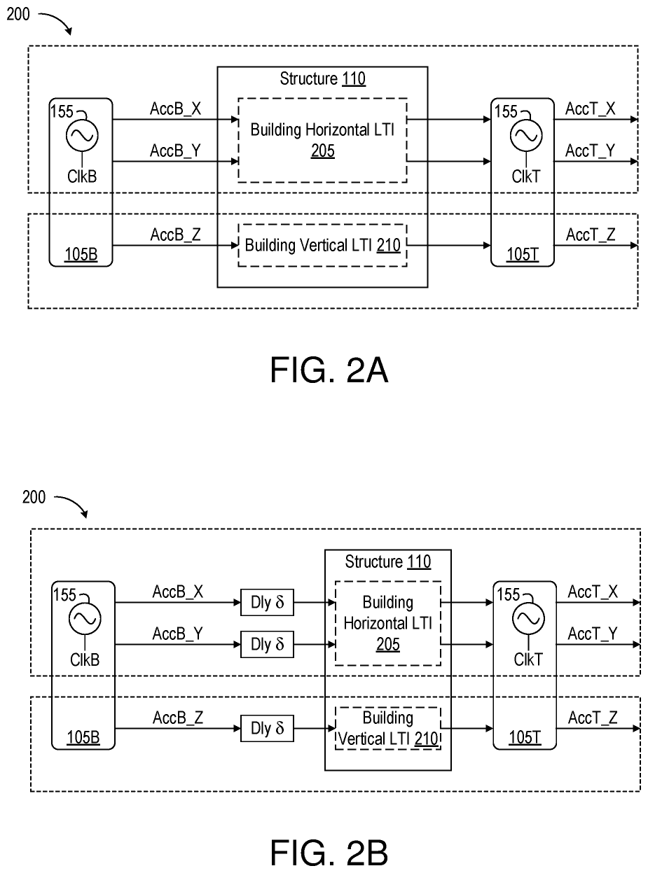

FIG. 2A depicts structure 110 and top and bottom motion detectors 105T and 105B as a system 200 in which bottom detector 105B is input—receives ground motion directly—and top detector 105T is output—receives the ground motion propagated through structure 110. As is typical of buildings, the stiffness of structure 110 in the vertical (Z) dimension tends to be considerably greater than the stiffnesses in the horizontal (X and Y) dimensions. The vertical and horizontal responses of structure 110 are largely decoupled, a property illustrated in FIG. 2A using separate bounding boxes. Structure 110 is modeled as a pair of LTI systems, a horizontal LTI system 205 for conducting vibrations in the horizontal (X and Y) plane and a vertical LTI system 210 for conducting vibrations in the vertical (Z) dimension.

Detectors 105B and 105T are shown to provide respective trios of acceleration signals AccB[X,Y,Z] and AccT[X,Y,Z]. These represent continuous or discrete (sampled) acceleration signals that can be processed together to calculate inter-detector acceleration in three dimensions. The information conveyed in this example is not via these signals, however, but is rather motion-induced vibrations that traverse structure 110, from based to top in the case of an earthquake. Differences between acceleration signals AccB[X,Y,Z] and AccT[X,Y,Z] are functions of the vibrational stimulus and the frequency responses of structure 110 in three dimensions. Accurate measurements of the relative accelerations represented by signals AccB[X,Y,Z] and AccT[X,Y,Z] require precise synchronization between detectors 105B and 105T.

FIG. 2B depicts system 200 of FIG. 2A with delays Dly_d that represent a synchronization error between clock signals ClkB and ClkT within the bottom and top motion detectors 105B and 105T, respectively. These delays add to or subtract from differences due to horizontal and vertical LTIs 205 and 210, and thus confound computations of relative accelerations between detectors 105B and 105T. These errors, in turn, produce errors in computed values of building stress.

Table 1, below, shows the lowest natural frequencies in the horizontal (X and Y) and vertical (Z) dimensions for an illustrative building modeled as horizontal and vertical LTI systems conducting vibrations in three dimensions.

TABLE 1
Building Natural Frequencies

| LTI System | Lowest Natural Frequency |
|---|---|
| Horizontal | 0.6 Hz |
| Vertical | 12 Hz |

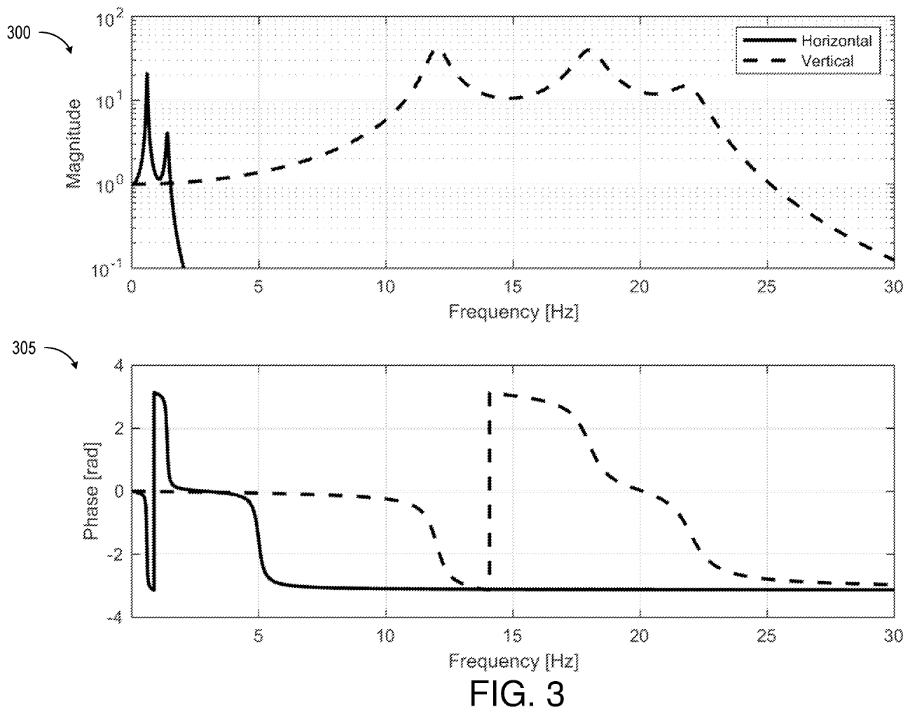

FIG. 3 includes plots 300 and 305 of magnitude and phase transfer functions that represent the response of a structure 110 as a function of frequency over a spectrum of from zero to 30 Hz. The solid lines represent the frequency response of horizontal LTI 205 and the dashed lines the frequency response of vertical LTI 210. At 0 Hz, both horizontal and vertical LTIs 205 and 210 act as a rigid body with an amplification factor of one. Ground motion is amplified near the natural frequencies of structure 110, those of horizontal LTI 205 below about 3 Hz and those of vertical LTI 210 above about 10 Hz.

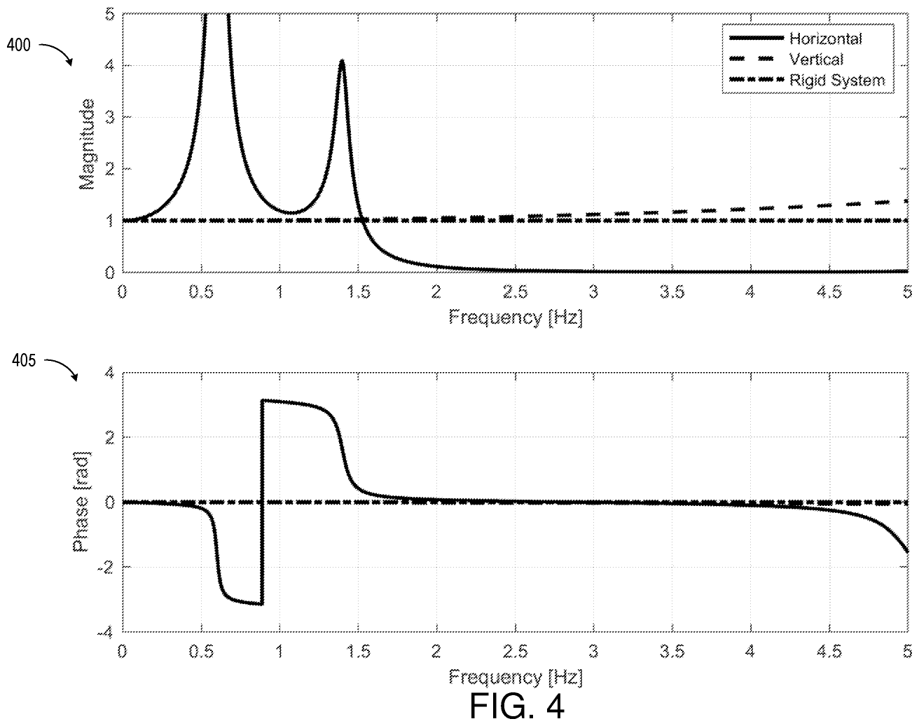

FIG. 4 includes plots 400 and 405 that are like plots 300 and 305 of FIG. 3 but depict magnitude and phase transfer functions over a spectrum of from zero to 5 Hz. Each plot additionally includes a trace for an ideal rigid system, as indicated in a key at upper right. In this frequency range, the response of horizontal LTI diverges dramatically from that of the ideal rigid system, whereas the vertical LTI 210 approximates the ideal.

Returning to FIG. 2B, synchronization errors represented as delays Dly_d add to or subtract from timing mismatches between accelerometer signals AccB[X,Y,Z] from detector 105B and accelerometer signals AccT[X,Y,Z] from detector 105T. The resultant misalignment reduces the accuracy and precision of the relative motion between detectors 105B and 105T. In the horizontal dimensions, this means detectors 105B and 105T can produce inaccurate measures of building response to an earthquake, for example.

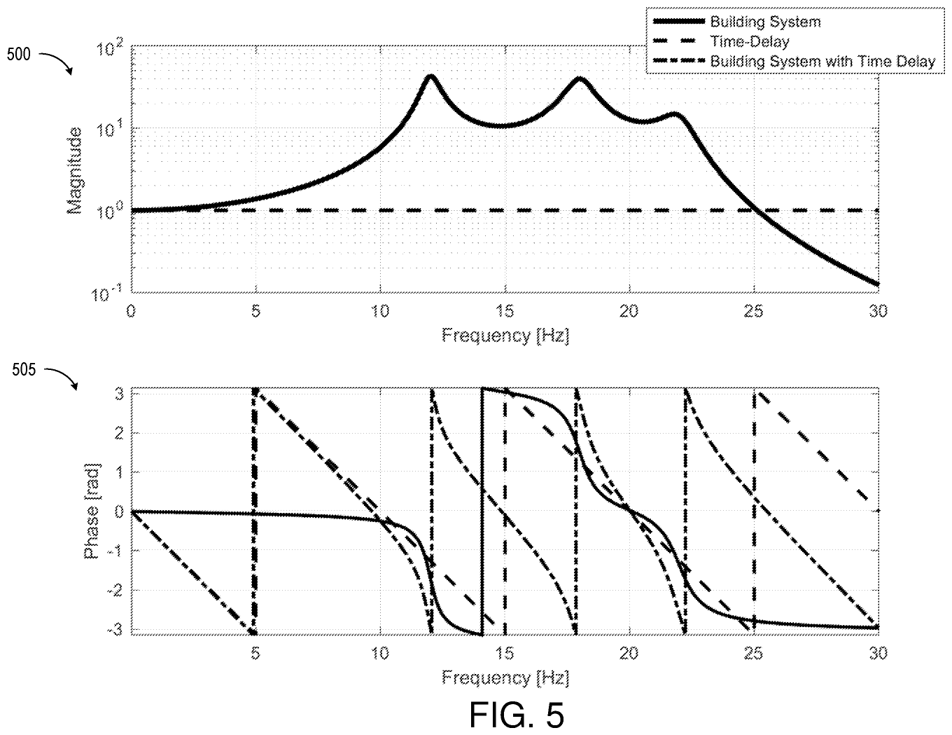

FIG. 5 includes plots 500 and 505 of magnitude and phase transfer functions that represent the vertical response of a structure 110—the response of vertical LTI 210—over a spectrum of from zero to 30 Hz. An added time delay does little to nothing to distort magnitude plot 500 but does appear clearly in phase plot 505, particularly at higher frequencies.

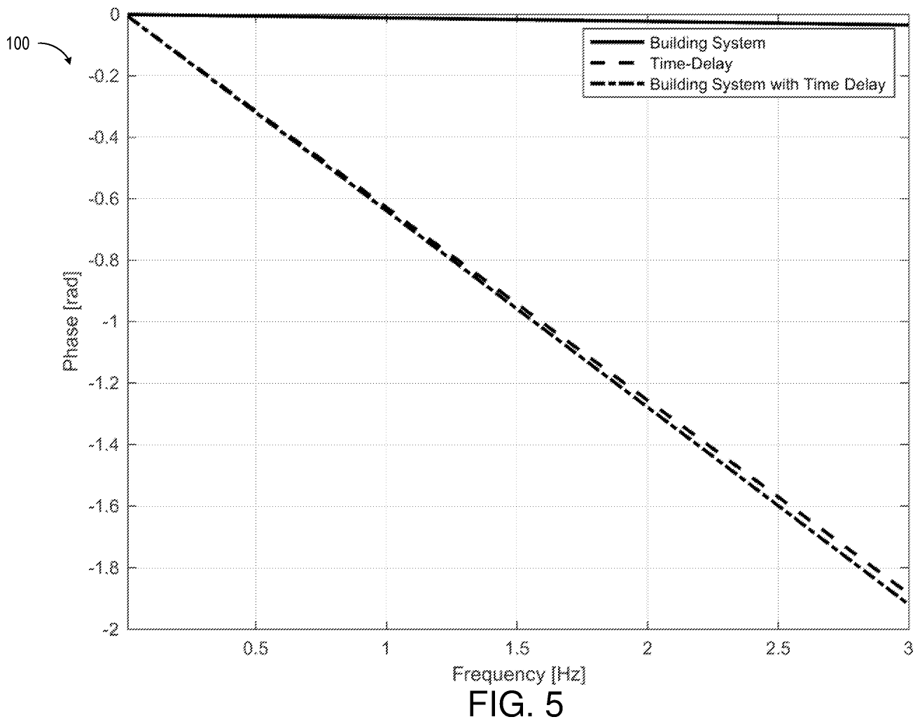

FIG. 6 depicts a plot 600 of phase plot 505 of FIG. 5—the phase response of vertical LTI 210—over the narrower spectrum of from zero to 3 Hz, both with and without a time delay between clock signals ClkB and ClkT. Over this range, the phase shift between motion detectors 105B and 105T as a consequence of vertical LTI 210 is small relative to the exemplary time delay. The phase offset between accelerometer signals AccB_Z and AccT_Z thus provides a reasonably accurate measure of the offset between clock signals ClkB and ClkT. A processor or processors with access to signals AccB_Z and AccT_Z can thus produce a measure of delay Dly_δ, a synchronization error common to the horizontal accelerometer signals in detectors 105B and 105T.

Measurements of building dynamics prioritize horizontal displacement. With reference to FIG. 1A, for example, the primary destructive forces imposed on structure 110 by an earthquake or wind-shear event cause the top of structure 110 to move laterally (in the horizontal plane of the X and Y axes) relative to the base. Horizontal acceleration signals from top detector 105T will thus differ from those of bottom detector 105B, the difference being a function of the flexion and stress applied to structure 110. Clock synchronization errors between detectors 105B and 105T confound measures of relative acceleration and thus introduce errors in stress computation. Measured phase error Dly_δ can be used to offset the phase errors and thus improve stress computations.

The contribution Φ(f) of delay Dly_δ to the measured horizontal phase response of structure 110 can be approximated by the linear equation: Φ(f)=−2πf(Dly_δ). This value can be subtracted from the measured horizontal phase response to provide a more accurate value for the response of the horizontal LTI 205 of structure 110.

The local clock signals within separated motion detectors 105 can drift relative to one another over time. Phase delay Dly_δ is thus updated as needed. For example, the vertical responses of detectors 105B and 105T of FIG. 1A to an earthquake can be used to update phase delay Dly_δ before calculating horizontal displacement and concomitant building stress. In some embodiments, the rigid-body approximation for the vertical axis of a building under observation can be validated experimentally using e.g. a building's ambient noise response. One can validate, for example, that the lowest natural frequency along a vertical dimension is above a threshold of e.g. 5 Hz. Some embodiments include more motion detectors, in which case the same methods can be used to manage inter-detector phase offsets between them, as any two detectors can be represented using a linear model.

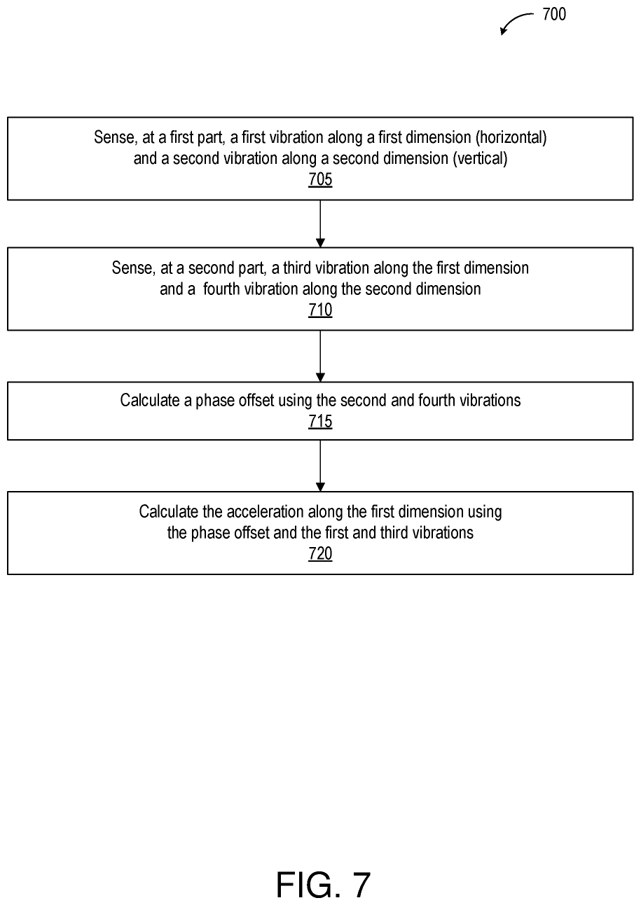

FIG. 7 is a flowchart 700 outlining a method of measuring acceleration, due to e.g. an earthquake, along a horizontal dimension between disparately timed motion sensors placed apart from one another within a structure. Vibrations are sensed vertically and horizontally at a first part of the structure (e.g. near the bottom) and the sensed acceleration signals are sampled using a first timing reference (step 705). The vibrations are also sensed vertically and horizontally at a second part of the structure (e.g. near the top) and the sensed acceleration signals are sampled using a second timing reference (step 710). The sampled vertical acceleration signals from the detectors are then used to calculate a phase offset between the first and second timing references (step 715). The acceleration along the horizontal dimension between the motion sensors is then calculated from the sampled horizontal acceleration signals and the phase offset (720). The method of flowchart 700 works best if spaced motion sensors are subjected to relatively strong motions. Systems or sensors in accordance with some embodiments request or report motion data when the motion exceeds a threshold. In some embodiments, sensors report motion data to remote server that performs the calculations of e.g. step 715 for periods of significant motion.

While the subject matter has been described in connection with specific embodiments, other embodiments will be evident to those of skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. A system for analyzing a motion of a structure, the system comprising:
multi-axis accelerometers each including a first accelerometer to produce a first acceleration signal responsive to a motion of a structure along a first axis and a second acceleration signal responsive to the motion of the structure along a second axis; and
at least one processor to calculate an offset between the first accelerometer signals of the multi-axis accelerometers and a displacement between the multi-axis accelerometers along the second axis using the second acceleration signals of the multi-access accelerometers and the offset.

2. The system of claim 1, wherein the first axis is orthogonal to the second axis.

3. The system of claim 1, wherein the structure comprises a building, the first axis extends through the building in a vertical dimension, and the second axis extends through the building in a horizontal dimension.

4. The system of claim 1, each multi-axis accelerometer further including a third accelerometer to produce a third acceleration signal responsive to the motion of the structure along a third axis.

5. The system of claim 4, wherein the third axis is orthogonal to the first axis and the second axis.

6. The system of claim 1, the at least one processor to calculate, using the phase offset, a displacement of one of the multi-axis accelerometers relative to another of the multi-axis accelerometers.

7. A method of measuring acceleration along a first dimension through a structure, the acceleration responsive to a motion of the structure, the method comprising:
sensing, at a first part of the structure and responsive to the motion, a first vibration conducted through the structure along the first dimension and a second vibration conducted through the structure along a second dimension;
sensing, at a second part of the structure and responsive to the motion, a third vibration conducted through the structure along the first dimension and a fourth vibration conducted through the structure along the second dimension;
calculating an offset between the second and fourth vibrations conducted through the structure along the second dimension; and
calculating the acceleration along the first dimension through the structure from the phase offset and the first and third vibrations conducted through the structure along the first dimension.

8. The method of claim 7, wherein the first dimension is orthogonal to the second dimension.

9. The method of claim 8, wherein the first dimension extends horizontally, and the second dimension extends vertically.

10. The method of claim 7, the method further to measure acceleration in a third dimension orthogonal to the second dimension, the method further comprising calculating the acceleration in the third dimension from the phase offset and vibrations conducted through the structure along the third dimension.

11. The method of claim 7, wherein the structure comprises a building.

12. The method of claim 11, wherein the building exhibits a first natural frequency in the first dimension and a second natural frequency greater than the first natural frequency in the second dimension.

13. The method of claim 12, wherein the second natural frequency is more than thrice the first natural frequency.

14. The method of claim 13, wherein the first natural frequency of less than three Hertz.
